(19) United States
(12) Patent Application Publication
(10) Pub. No.: US 2014/0074757 A1
(43) Pub. Date: Mar. 13, 2014

(54) ESTIMATING TAXI FARE

(71) Applicants: Steven V. De Gennaro, Pawling, NY (US); Pamela A. Nesbitt, Ridgefield, CT (US)

(72) Inventors: Steven V. De Gennaro, Pawling, NY (US); Pamela A. Nesbitt, Ridgefield, CT (US)

(73) Assignee: INTERNATIONAL BUSINESS MACHINES CORPORATION, Armonk, NY (US)

(21) Appl. No.: 13/606,307

(22) Filed: Sep. 7, 2012

(51) Int. Cl. G07B 13/04

(52) U.S. Cl. 705/417

(57) ABSTRACT

A method, computer usable program product or system for providing an estimated taxi fare to a passenger including providing a user interface (UI) for identifying a route and the estimated taxi fare for travelling the route in a taxi from a point of origin to a destination meeting a set of criteria, and responsive to the passenger utilizing the UI with the point of origin and identifying the destination, accessing a set of databases with a set of real-time information including traveling related information and pricing information, identifying the route and the estimated taxi fare for the route based upon the point of origin, the destination, the set of criteria, and the set of real-time information, and presenting the estimated taxi fare to the passenger.

### BACKGROUND

1. Technical Field

The present invention relates generally to estimating a taxi fare, and in particular, to a computer implemented method for estimating a taxi fare utilizing real-time information.

2. Description of Related Art

Taxis typically charge fares based on trip distance and time travelled. Taxi drivers typically have many choices of routes to take to the customer's destination, of which some may be faster but for a longer distance and others may be slower but for a shorter distance. In addition, if the customer is deemed by the taxi driver to not be unfamiliar with the city, the taxi driver may select a route that is less than ideal for the customer in order to increase the fare.

Customers may ask for an estimate of travel time to a destination, particularly if the customer is headed to an appointment or other scheduled commitment such as a flight. Depending on the experience of the taxi driver, the estimate may be somewhat accurate or not. In addition, the taxi driver has an incentive to underestimate the travel time in order to not lose the prospective customer.

### SUMMARY

The illustrative embodiments provide a method, system, and computer usable program product for providing an estimated taxi fare to a passenger including providing a user interface (UI) for identifying a route and the estimated taxi fare for travelling the route in a taxi from a point of origin to a destination meeting a set of criteria, and responsive to the passenger utilizing the UI with the point of origin and identifying the destination, accessing a set of databases with a set of real-time information including traveling related information and pricing information, identifying the route and the estimated taxi fare for the route based upon the point of origin, the destination, the set of criteria, and the set of real-time information, and presenting the estimated taxi fare to the passenger.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of a data processing system in which various embodiments may be implemented;

FIG. 2 is a block diagram of a network of data processing systems in which various embodiments may be implemented;

FIG. 3 is a diagram of a taxi fare estimation system in accordance with a first embodiment;

FIGS. 4A through 4C are block diagrams of a driver system, passenger touchscreen and server in accordance with a first embodiment;

FIG. 5 is a flow diagram of a user interface for estimating a taxi fare in accordance with a first embodiment;

FIG. 6 is an illustration of a map showing multiple routes on a map in which various embodiments may be implemented;

FIG. 7 is a diagram of a taxi fare estimation system in accordance with a second embodiment;

FIG. 8A through 8D are block diagrams of a driver system, passenger touchscreen, server and mobile phone in accordance with a second embodiment; and

FIG. 9 is a flow diagram of a user interface for estimating a taxi fare in accordance with a second embodiment.

### DETAILED DESCRIPTION

Steps may be taken to estimate a taxi fare utilizing real-time information. These steps may be taken as will be explained with reference to the various embodiments below.

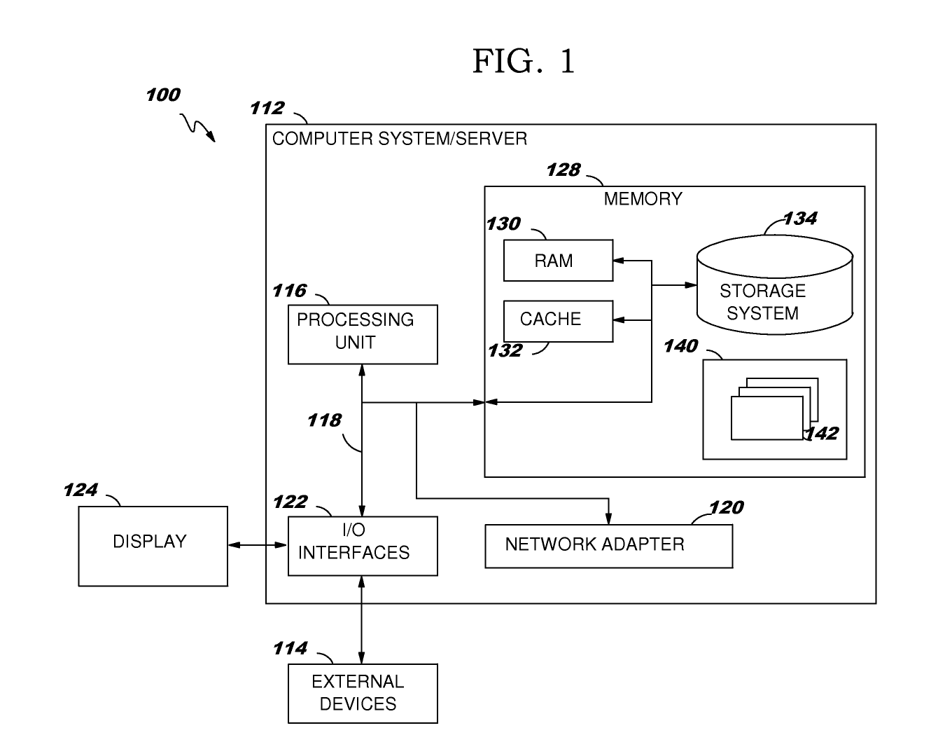

FIG. 1 is a block diagram of a data processing system in which various embodiments may be implemented. Data processing system 100 is only one example of a suitable data processing system and is not intended to suggest any limitation as to the scope of use or functionality of embodiments of the invention described herein. Regardless, data processing system 100 is capable of being implemented and/or performing any of the functionality set forth herein.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, and it includes both volatile and non-volatile media, removable and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example only, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of embodiments of the invention. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of embodiments of the invention. For example, a program module may be software for estimating a taxi fare.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, redundant processing units, external disk drive arrays, RAID systems, tape drives, and data archival storage systems, etc.

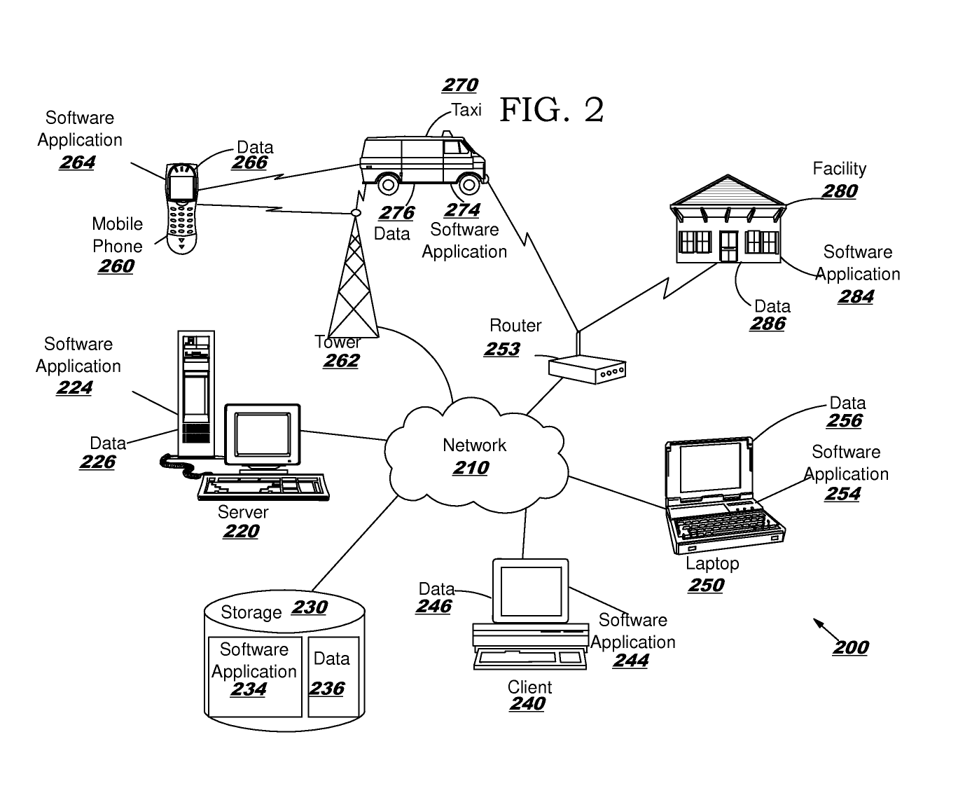

FIG. 2 is a block diagram of a network of data processing systems in which various embodiments may be implemented. Data processing environment 200 is a network of data processing systems such as described above with reference to FIG. 1. Software applications may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile phone 260 may be coupled to network 210 through a mobile phone tower 262. Data processing systems, such as server 220, client 240, laptop 250, mobile phone 260, taxi 270 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for estimating a taxi fare or other software applications and data in accordance with embodiments described herein. Storage 230 may contain software application 234 and a content source such as data 236 for estimating a taxi fare. Other software and content may be stored on storage 230 for sharing among various computer or other data processing devices. Client 240 may include software application 244 and data 246. Laptop 250 and mobile phone 260 may also include software applications 254 and 264 and data 256 and 266. Taxi 270 and facility 280 may include software applications 274 and 284 and data 276 and 286. Other types of data processing systems coupled to network 210 may also include software applications. Software applications could include a web browser, email, or other software application that can estimate a taxi fare.

Server 220, storage unit 230, client 240, laptop 250, mobile phone 260, taxi 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, taxi 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

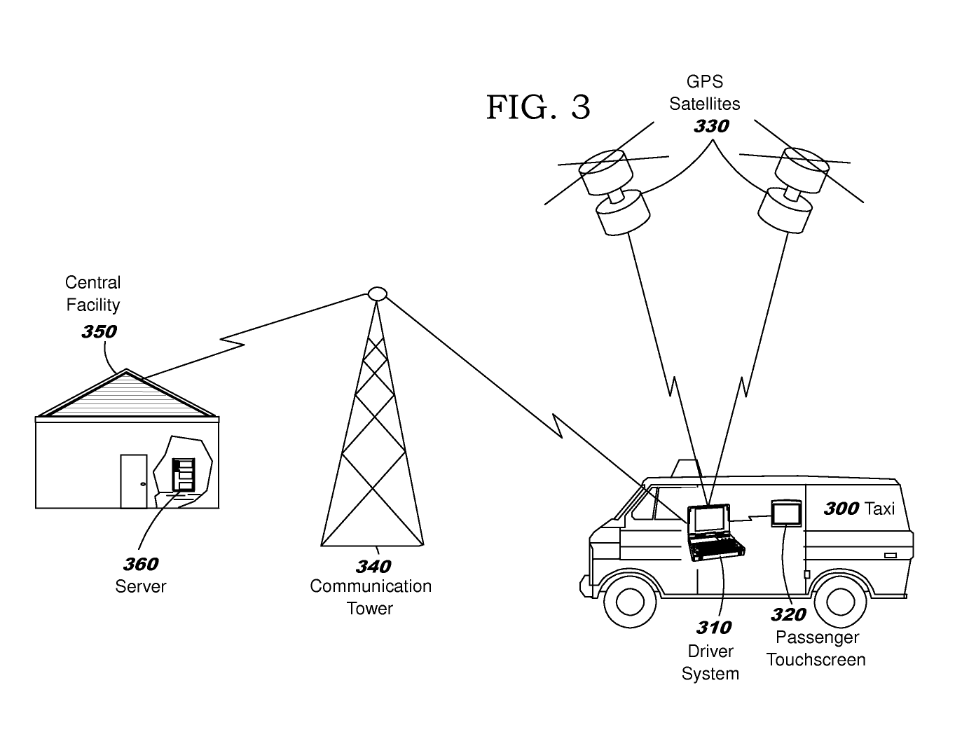

FIG. 3 is a diagram of a taxi fare estimation system in accordance with a first embodiment. A taxi 300 is shown for transporting passengers to destinations desired by the passenger in exchange for money or other form of remuneration. A taxi may be a car, van, tuk-tuk, or other type of vehicle such as a boat. A taxicab is a type of taxi utilized on roads such as streets and highways. A taxi fare is the total charge by a taxi for transporting one or more passengers from a point of origin to a destination. A taxi fare can include a charge for time and distance travelled, zones that may be crossed, additional fees for travel to airports, tolls, etc. A taxi fare in many cities may be a standard charge for certain routes (such as from downtown to an airport) or it may be dynamic based on time of day or other considerations. For example, Singapore has implemented congestion pricing or real-time variable pricing in order to reduce traffic congestion. In addition, London has a congestion charge zone where an extra toll is charged in central London during certain hours.

Taxi 300 is shown with a driver system 310 in communication with a passenger touchscreen 320. This communication may be wired or wireless such as by near field communications. Driver system 310 is also in communication with GPS (global positioning system) satellites 330 for determining the position of the taxi. Driver system 310 is further in communication through communications tower 340 with a central facility 350 and in particular with a server 360 at or in communication with the central facility. These communications may be by radio, cellular, or other type of wireless communication.

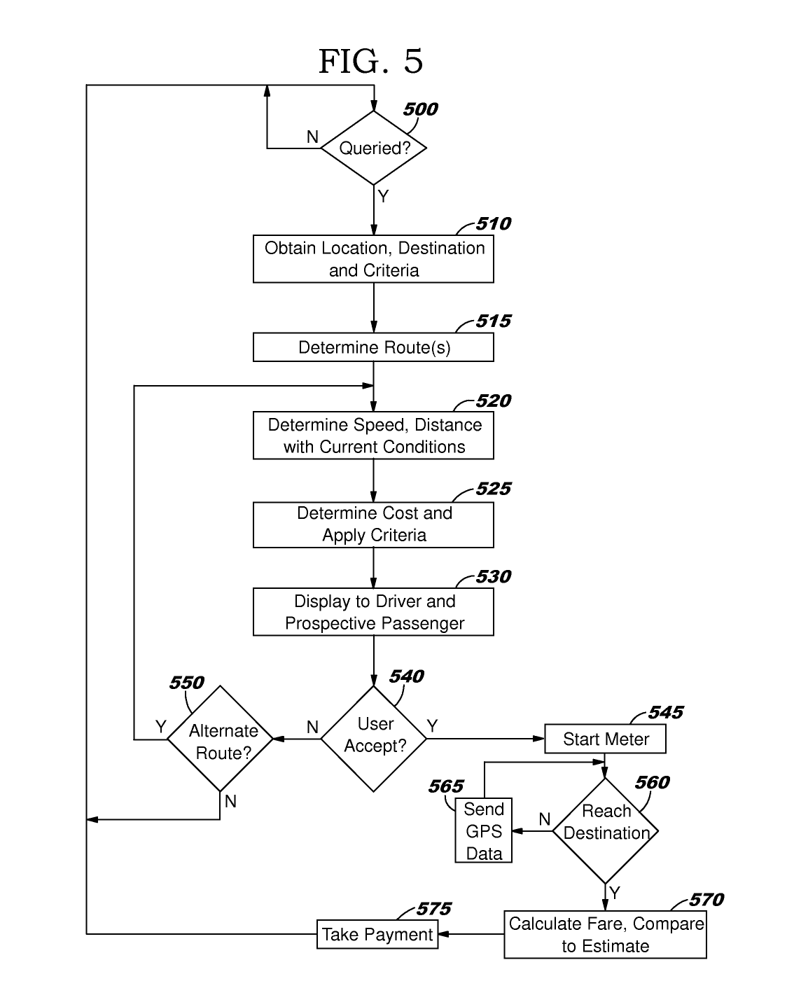

Driver system 310 is utilized by the driver for many functions. Driver system 310 in communication with server 360 can provide an estimated fare for a prospective passenger as described below with reference to FIG. 5. The estimated fare can include time, distance, multiple routes, each with their own estimated fare information, etc. The estimated time and distance for each route can take into account real-time (i.e. up to date and dynamic) information such as current road congestion. This information may be communicated with the prospective passenger through passenger touchscreen 320. The prospective passenger may approve, select alternative routes, of reject through the touchscreen interface or by communicating with the driver who enters the information into the driver system.

Once the prospective passenger accepts the ride, the driver system determines an ongoing fare and displays that fare on the passenger touchscreen for the passenger. As a result, the passenger can see if the taxi is travelling faster or slower than estimated. Once the ride for the passenger is complete, the driver system provides the final actual fare to the passenger on the touchscreen for payment. A comparison of the actual fare with the estimated fare can be generated and displayed for the passenger prior to payment. Depending on the difference, a discount may be provided. The passenger may pay by cash or credit card. If by cash, the driver can enter the amount on the driver system to show payment was received and the amount of any tip received. If by credit card or other electronic means, the driver system can help manage the payment by communicating with the appropriate credit card company through server 360 for approval of the transaction through server 360. The driver system or a unit in communication with the driver system can also determine the location of taxi 300 by communication with GPS (global positioning system) satellites 330. This location and any planned route can be shown on a map displayed on the driver system and the passenger touchscreen. This location can also be periodically communicated to server 360 for helping the server determine current road conditions along the route travelled by the taxi, thereby improving fare estimates to other prospective customers.

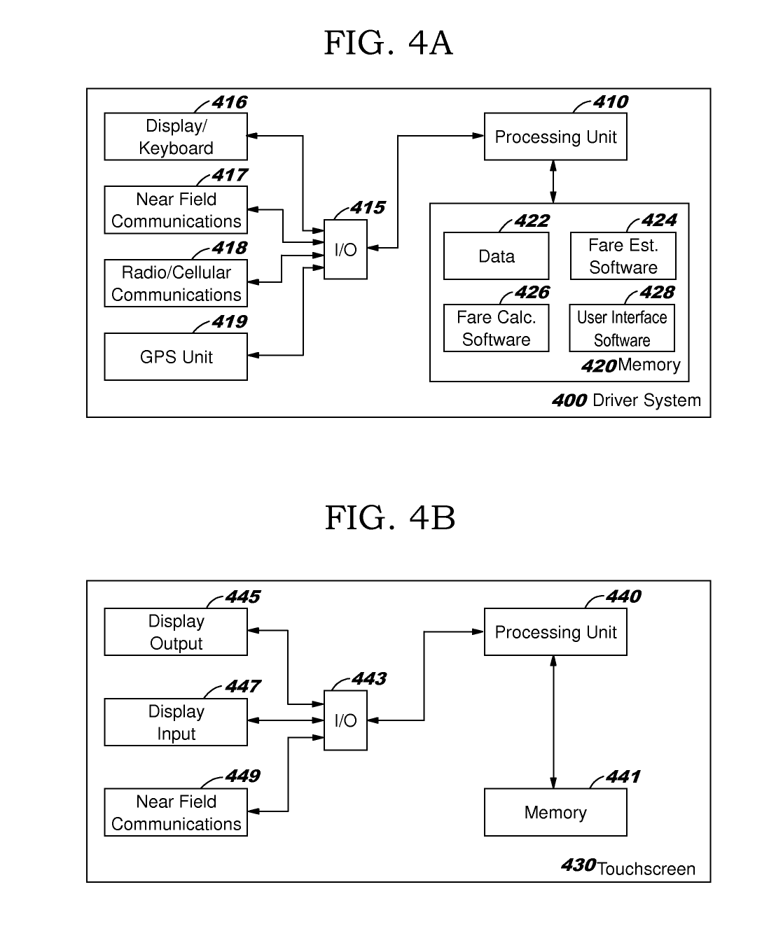

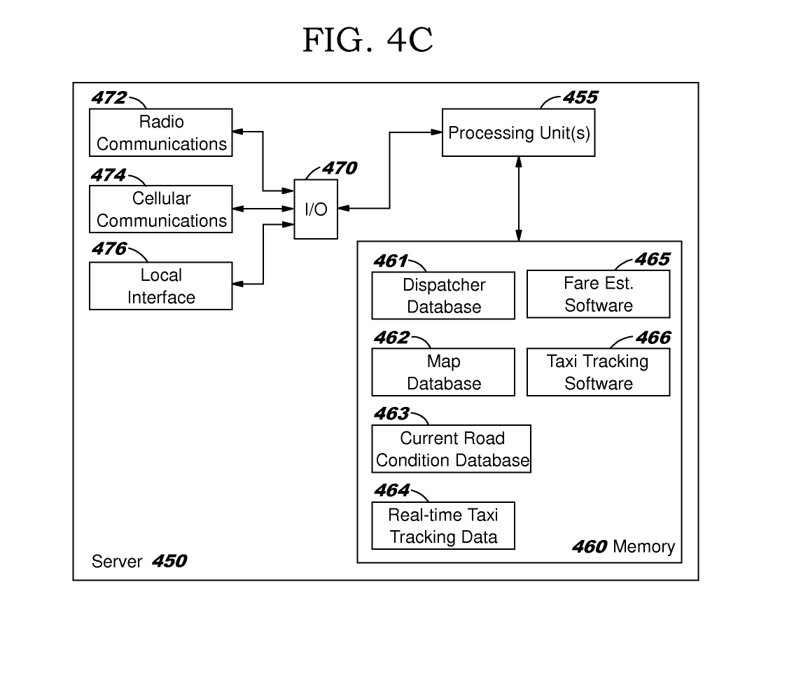

FIGS. 4A through 4C are block diagrams of a driver system, passenger touchscreen and server in accordance with the first embodiment. Driver system 400, touchscreen 430, and server 450 correspond respectively to driver system 310, touchscreen 320, and server 360 described above with reference to FIG. 3. Each of these elements may be standard off the shelf devices that have had software and data added for desired functionality, or the elements may be specially designed hardware and software designed for the desired functionality.

In FIG. 4A driver system 400 is shown with a processing unit 410 and memory 420. Memory 420 may include data 422, fare estimation software 424, fare calculation software 426, and user interface software 428. The processing unit may communicate through an I/O (input/output) device 415 to a display/keyboard 416, near field communications unit 417, radio/cellular communications unit 418 and GPS unit 419.

User interface 428 is utilized by processor 410 for interfacing with a driver and passenger. User interface 428 utilizes the fare estimation software and fare calculation software to generate and provide information to the driver and/or driver based on input from them. Fare estimation software 424 is utilized by the user interface to provide an estimate of a fare based on a current location of the taxi, the destination of the prospective passenger, and any criteria the prospective passenger may provide such as a request to minimize cost, to minimize time traveled, or some combination such as to get to the destination within 20 minutes with the cheapest fare possible within that timeframe. The current location can be determined by internal GPS unit 419, an external GPS unit in communication with processing unit 410 through I/O device 415, or other electronic means. The destination and criteria is provided by the prospective passenger and may be entered by the driver through display/keyboard 416, by the prospective passenger through near field communications unit 417 to touchscreen 430, or by other types of communication such as voice recognition. Fare estimation software can then determine various routes including respective fare costs and travel time estimations for display to the driver and prospective passenger by the user interface through display/keyboard 416 and through near field communications to touchscreen 430. In this embodiment, the fare estimation software in the driver system utilizes server 450 and fare cost information in data 422 to provide the estimates based on a variety of factors including current road conditions. The prospective passenger can then either approve or reject the estimates or provide alternative routes for further estimation to the user interface utilizing touchscreen 430 or by communication with the driver who enters the selection to the user interface utilizing display/keyboard 416.

Once the prospective passenger has accepted the ride and the trip has started, the user interface utilizes fare calculation software 426 to calculate an ongoing fare as well as a final fare for display on display/keyboard 416 and touchscreen 430. Fare calculation software 426 may utilize data 422 for information such as cost per distance driven, cost per time traveled, etc. Fare calculation software 426 may utilize GPS unit 419 for distance traveled or communicate with the taxi odometer through near field communication unit 417. Final payment by the passenger may be made through a credit card reader or other electronic means also in communication with the driver system through near field communication unit 417. Approval for the credit card or other electronic payment may be obtained through radio/cellular communications 418 to server 450 to a third party approver such as a credit card company.

Driver system 400 can also provide taxi location information to server 450 by obtaining that information from GPS unit 419 and relaying that information to server 450 through radio/cellular communications 418. This information may be useful for the central facility to dispatch the taxi to a prospective passenger, and for the central facility to determine road conditions based on the travel history of the taxi.

Driver system 400 may perform other functions not described herein such as maintaining financial data for reporting and/or tax collection purposes, maintenance information regarding the taxi including scheduling upcoming maintenance, etc. Other types of hardware and software may communicate with driver system 400 such as driver systems from other taxis

In FIG. 4B touchscreen 430 is shown with a processing unit 440 and memory 441. The processing unit may communicate through an I/O (input/output) device 443 to a display output 445, a display input 447 and a communications unit 449. Since the touchscreen is utilized for both input and output, separate communication units are shown, although alternative embodiments may utilize other configurations. Communications 449 may be a near field communications unit for communicating with driver system 400 or other systems as desired by the driver. Touchscreen 430 is configured as a relatively dumb terminal to driver system 400 in this embodiment, although other configurations may be utilized. Alternative embodiments may utilize other types of devices for communication with the passenger such as a terminal with a display and mouse.

In FIG. 4C server 450 is shown with a processing unit(s) 455 and memory 460. Processing unit(s) 455 may be a single processor, multi-processor, or even a cloud configuration across the internet. Memory 460 may include dispatcher database 461, map database 462, current road condition database 463, real-time taxi tracking data 464, fare estimation software 465 and taxi tracking software 466. The processing unit may communicate through an I/O (input/output) device 470 to a radio communications unit 472, cellular communications unit 474 and a local interface 476. Radio communications unit 472 and cellular communications unit 474 may be utilized to communicate with a taxi driver system. Local interface 476 may be utilized by a person conducting maintenance on the server, or for lining with third party providers to obtain real-time road condition information. Other types of software and hardware may be utilized in alternative embodiments.

Dispatcher database 461 includes information useful for dispatching taxis to prospective passengers include records of each taxi including the type of taxi (e.g. car or van), handicap capabilities (e.g. can handle wheelchair bound passengers, driver name and contact information, general area of coverage, and real-time information such as current location and whether the taxi is currently available or not.

Map database 462 includes mapping information of the area of prospective passengers, typically a city and surrounding areas. This includes information needed to generate possible routes such as street location and length, which streets intersect and which locations, whether a given street is one-way, etc. In this embodiment, a map is composed of a set of road segments and intersections, each segment representing a portion of a road, such as between intersections with other roads. Information about each segment can include distance, number of lanes, direction, speed limit, etc. Information about each intersection may include whether there is a stop sign or traffic light, which road has priority, etc.

Current road condition database 463 includes real-time information about current traveling conditions and pricing of road segments and intersections as well as static conditions and pricing. Current traveling information maintained real-time includes location events (e.g. sports events, parades), weather conditions, speed limits, road projects, road conditions, traffic patterns, traffic congestions, traffic light information, etc. In addition, pricing information, which may be dynamic, includes taxi rates and tolls. Much of this information may be real-time such as current actual speeds of vehicles at various locations within the coverage area or identification of areas where lanes may be closed or potholes may exist, etc. Some of this real-time information may be provided by third party vendors or information from the real-time taxi tracking data.

Real-time taxi tracking data 464 includes real-time information about the taxis being tracked throughout the coverage area. This may be used to modify or supplement the road condition database. This information is obtained from the GPS units of each taxi that transmits this information to the server real-time. This information may be segregated by taxis that are currently transporting passengers and those that are not currently transporting passengers. If a taxi is not transporting a passenger, that taxi may drive more slowly by locations such as hotels and other business looking for passengers, thereby providing data that is not accurate for determining road conditions. This database is managed by taxi tracking software 466.

Fare estimation software 465 utilizes the map database 462 and road condition database 463 to estimate fares for a prospective passenger given the current location (point of origin), destination and criteria of the prospective passenger. More details of this software will be described below with reference to FIG. 5.

FIG. 5 is a flow diagram of a user interface for estimating a taxi fare in accordance with a first embodiment. The user interface can utilize fare estimation software 426 and fare estimation software 465 to generate and provide an estimated fare for a prospective passenger.

In a first step 500, the user interface determines whether it has been queried for estimation of a fare. If not then processing returns to step 500. This step is then performed repeatedly until a query is received or until the user interface is turned off by an operating system, typically at the request of the driver. If a query is received in step 500, then processing continues to step 510 where a point of origin (typically the location of the taxi), destination, and criteria of a prospective passenger is received, determined or otherwise obtained. In this embodiment, the current location of the prospective passenger is the location of the taxi which may be provided by the GPS unit of the driver system. The destination is provided by the passenger and may be entered by the drive on the driver system or by the passenger on the touchscreen. The criteria may include a request to minimize cost, to minimize time traveled, or some combination such as a request to get to the destination at a certain time such as for an appointment with the cheapest fare possible while meeting the destination time requested. If the prospective passenger does not provide criteria, default criteria may be utilized.

Subsequently in step 515, one or more routes from the passenger point of origin to the passenger destination are identified by the server fare estimation software using the map database at the request of the user interface and/or taxi fare estimation software. Then in step 520, the speed and distance of each route is determined by the server fare estimation software using the current road condition database. This information may be passed from the server fare estimation software to the driver system software. In step 525, the driver estimation software can then determine the cost of each route using the fare calculation software and data in the driver system memory. The earlier specified criteria are then applied to the set of routes. As a result, some routes may then be discarded based on their cost, time of travel or other criteria. Alternative embodiments may perform step 525 at the server and then provide the results to the driver system. Other alternative embodiments may repeat steps 515 through 525 seeking additional alternative routes which may better meet the criteria.

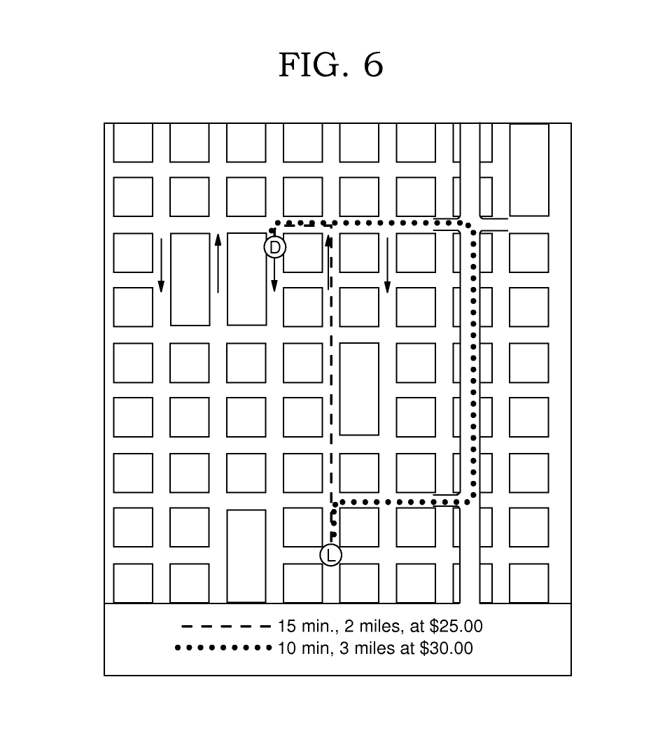

Subsequently in step 530, this information (e.g. routes, cost, distance, travel time, etc.) is displayed to the driver on the driver system display and to the prospective passenger on the touchscreen. An example of such a display of information is shown and described below with reference to FIG. 6. The prospective passenger can then review this information and either accept or reject the estimated fares for the given routes in step 540. If the prospective passenger rejects the proposed routes and estimated fares, then the passenger can provide possible alternate routes in step 550. If no such alternate is provided, the processing returns to step 500. If such an alternate is provided in step 550, then processing returns to step 520 for processing.

If the prospective passenger accepts a proposed route and estimated fare in step 540, then in step 545 the taxi meter is started, thereby initiating the driver system fare calculation software for calculating and displaying the actual ongoing fare to the passenger during the trip to the passenger destination along the route selected by the passenger. The actual ongoing fare may be constantly compared to an estimated time throughout the trip so the passenger can see whether the actual travel is ahead of or behind the estimated time. As the trip progresses, an internal query determines whether the taxi has reached the destination in step 560. This can be performed by comparing the current location of the taxi with the passenger destination or by the taxi driver indicating the destination has been reached through the driver system keyboard. If not, then the GPS data for the taxi is sent to the server in step 565 and processing returns to step 560. This information is utilized by the system server taxi tracking software to update the real-time taxi tracking data which is further used to update the road condition database.

If the destination has been reached in step 560, then in step 570 the final actual fare is calculated and compared to the estimated fare. This is displayed to the driver and user on the driver system display and the touchscreen display. In this embodiment, processing then continues to step 575 for collecting payment. In alternative embodiments, if the difference is significantly different to the passenger's detriment, then a discount may be provided to the passenger. In step 575, payment is received from the passenger and processing returns to step 500 above until another query is received.

FIG. 6 is an illustration of a map showing multiple routes on a map in which various embodiments may be implemented. This is an example view that may be generated by a user interface such as described with reference to a first and a second embodiment. A prospective passenger is located at location L (point of origin) and requests to travel to destination D. The fare estimation software provides two different routes shown as a dashed line and as a dotted line. Alternative embodiments may use colors or other methods to display multiple alternative routes. Other alternative embodiments may simply provide a list of alternatives, including cost and time of travel, without a map for the prospective passenger to choose from.

In this example, the shortest route is shown as the dashed line which includes traveling straight up a set of city blocks which may be congested with traffic and slowed by traffic lights. A longer but faster and more expensive route is shown as the dotted line which includes traveling over to a thoroughfare, up the thoroughfare, and back into the city blocks to the destination. In this example, the shorter 2 mile route only costs $25.00 but takes 15 minutes, whereas the longer 3 mile route costs $30.00, but only takes 10 minutes. This information is shown at the bottom of the map. The prospective passenger can then choose which route for the taxi to travel to the destination or select an alternative route through the user interface.

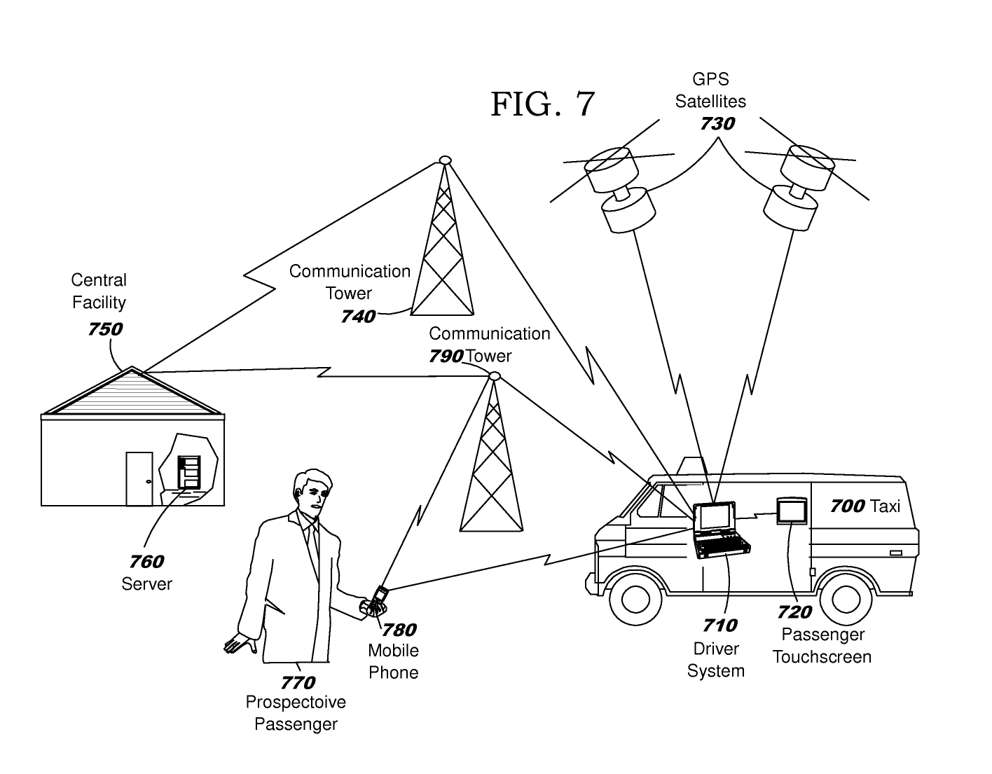

FIG. 7 is a diagram of a taxi fare estimation system in accordance with a second embodiment. A taxi 700 is shown for transporting passengers to destinations desired by the passenger in exchange for money or other form of remuneration. A taxi may be a car, van, tuk-tuk, or other type of vehicle such as a boat. A taxicab is a type of taxi utilized on roads such as streets and highways. A taxi fare is the total charge by a taxi for transporting one or more passengers from a point of origin to a destination. A taxi fare can include a charge for time and distance travelled, zones that may be crossed, additional fees for travel to airports, tolls, etc. A taxi fare in many cities may be a standard charge for certain routes (such as from downtown to an airport) or it may be dynamic based on time of day or other considerations. For example, Singapore has implemented congestion pricing or real-time variable pricing in order to reduce traffic congestion. In addition, London has a congestion charge zone where an extra toll is charged in central London during certain hours.

Taxi 700 is shown with a driver system 710 in communication with a passenger touchscreen 720. This communication may be wired or wireless such as by near field communications. Driver system 710 is also in communication with GPS (global positioning system) satellites 730 for determining the position of the taxi. Driver system 710 is further in communication through communications tower 740 with a central facility 750 and in particular with a server 760 at or in communication with the central facility. These communications may be by radio, cellular, or other type of wireless communication. Prospective passenger 770 is shown with a mobile phone 780. Mobile phone 780 is shown in communication with central facility 750 and taxi 700 through communications tower 790. Mobile phone is also shown in direct communication with taxi driver system 710 such as through near field communications.

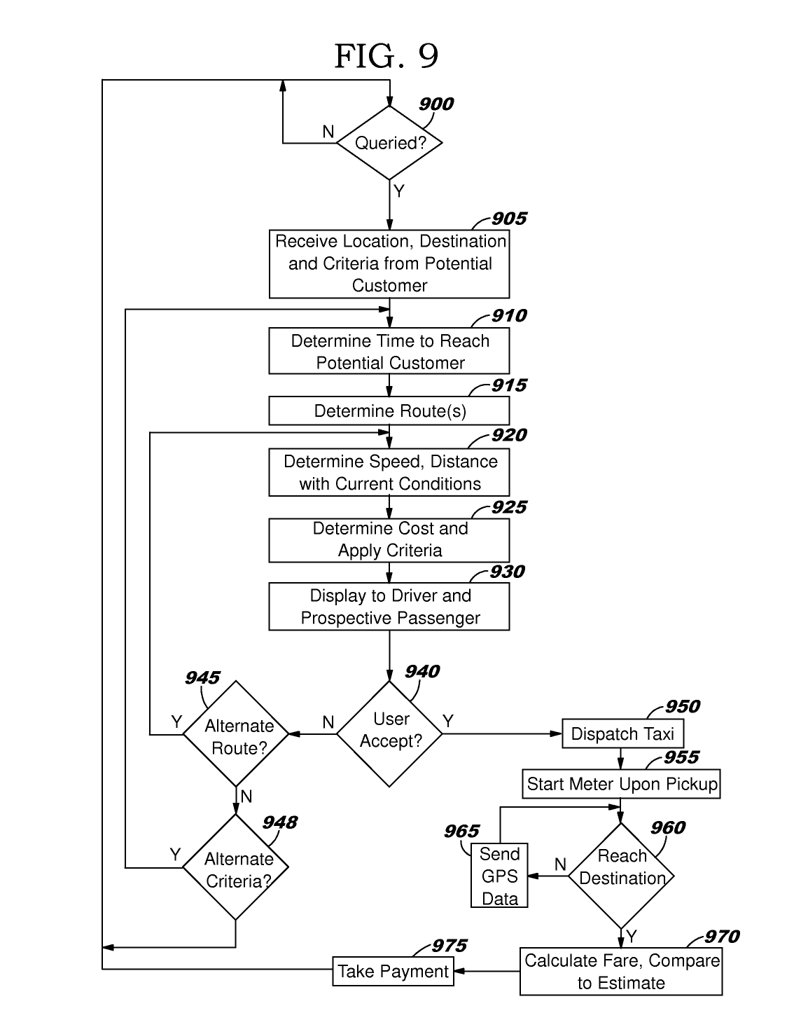

Mobile phone 780 is utilized by the prospective passenger for many functions. Mobile phone 780 in communication with server 760 can provide an estimated time of arrival of a taxi and an estimated fare for the prospective passenger as described below with reference to FIG. 9. The estimated fare can include time, distance, multiple routes, each with their own estimated fare information, etc. The estimated time and distance for each route can take into account real-time information such as current road congestion. This information may be communicated with the prospective passenger through mobile phone 780. The prospective passenger may approve, select alternative routes, of reject through the mobile phone, or alternatively by touchscreen 720 or by communicating with the driver who enters the information into the driver system.

Once the prospective passenger accepts the ride, taxi 700 is sent to pick up the passenger. Once the passenger is on board the taxi, the driver system determines an ongoing fare and displays that fare on the passenger touchscreen and/or the mobile phone for the passenger. As a result, the passenger can see if the taxi is travelling faster or slower than estimated. Once the ride for the passenger is complete, the driver system provides the final actual fare to the passenger on the touchscreen and/or the mobile phone for payment. A comparison of the actual fare with the estimated fare can be generated and displayed for the passenger prior to payment. Depending on the difference, a discount may be provided. The passenger may pay by cash or credit card. If by cash, the driver can enter the amount on the driver system to show payment was received and the amount of any tip received. If by credit card or other electronic means, the driver system can help manage the payment by communicating with the appropriate credit card company through server 760 for approval of the transaction through server 760. The driver system or a unit in communication with the driver system can also determine the location of taxi 700 by communication with GPS (global positioning system) satellites 730. This location and any planned route can be shown on a map displayed on the driver system and the passenger touchscreen. This location can also be periodically communicated to server 760 for helping the server determine current road conditions along the route travelled by the taxi, thereby improving fare estimates to other prospective customers.

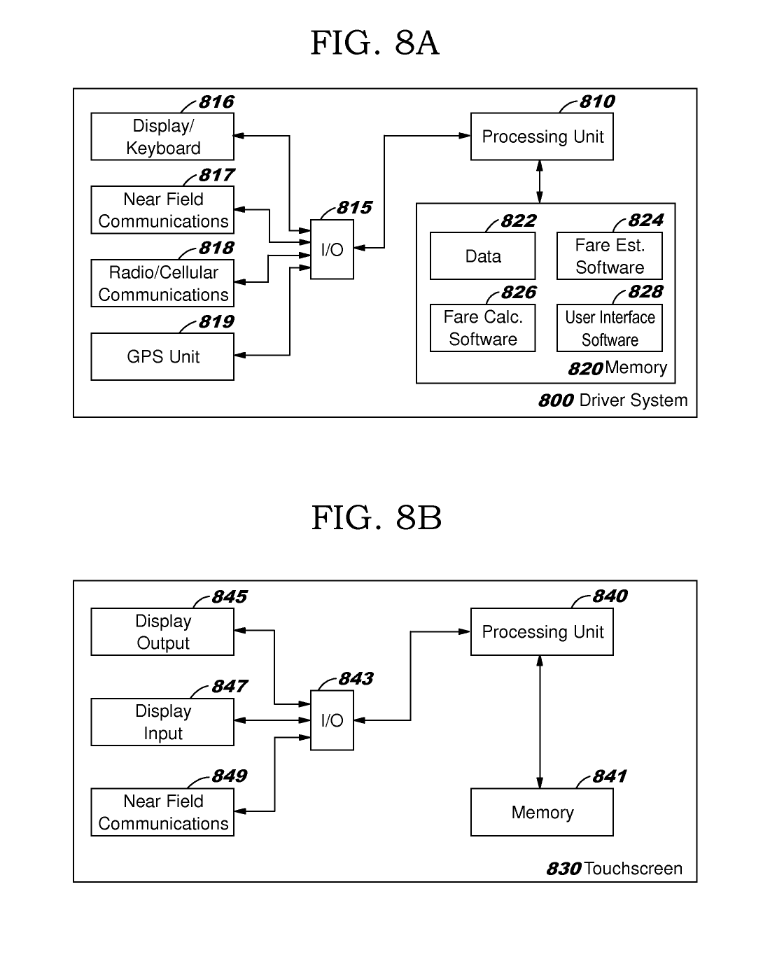

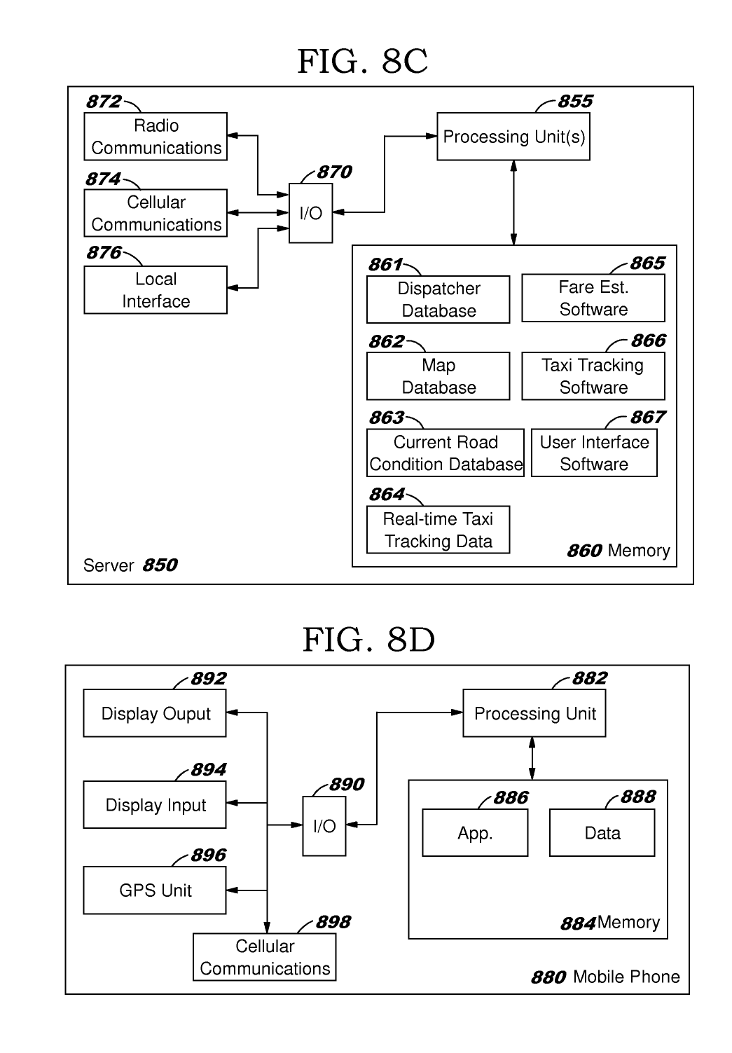

FIG. 8A through 8D are block diagrams of a driver system, passenger touchscreen, server and mobile phone in accordance with a second embodiment. Driver system 800, touchscreen 830, server 850, and mobile phone 880 correspond respectively to driver system 710, touchscreen 720, server 760 and mobile phone 780 described above with reference to FIG. 7. Each of these elements may be standard off the shelf devices that have had software and data added for desired functionality, or the elements may be specially designed hardware and software designed for the desired functionality.

In FIG. 8A driver system 800 is shown with a processing unit 810 and memory 820. Memory 820 may include data 822, fare estimation software 824, fare calculation software 826, and user interface software 828. The processing unit may communicate through an I/O (input/output) device 815 to a display/keyboard 816, near field communications unit 817, radio/cellular communications unit 818 and GPS unit 819.

User interface 828 is utilized by processor 810 for interfacing with a driver and passenger. This user interface may be invoked by a server user interface once the taxi is dispatched to pick up the passenger or if meeting a prospective passenger without dispatch such as at a hotel or on the street. User interface 828 can utilize the fare estimation software and fare calculation software to generate and provide information to the driver and/or driver based on input from them. If not already performed by the server, fare estimation software 824 can be utilized by the user interface to provide an estimate of a fare based on a current location of the taxi, the destination of the prospective passenger, and any criteria the prospective passenger may provide such as a request to minimize cost, to minimize time traveled, or some combination such as to get to the destination within 20 minutes with the cheapest fare possible within that timeframe. The current location can be determined by internal GPS unit 819, an external GPS unit in communication with processing unit 810 through I/O device 815, or other electronic means. The destination and criteria is provided by the prospective passenger and may be entered by the driver through display/keyboard 816, by the prospective passenger through near field communications unit 817 to touchscreen 830, though mobile phone 880, or by other types of communication such as voice recognition. Fare estimation software can then determine various routes including respective fare costs and travel time estimations for display to the driver and prospective passenger by the user interface through display/keyboard 816 and through near field communications to touchscreen 830. The fare estimation software in the driver system can utilize server 850 and fare cost information in data 822 to provide the estimates based on a variety of factors including current road conditions. The prospective passenger can then either approve or reject the estimates or provide alternative routes for further estimation to the user interface utilizing touchscreen 830 or by communication with the driver who enters the selection to the user interface utilizing display/keyboard 816.

Once the prospective passenger has accepted the ride, has been picked up by the taxi, and the trip has started, the user interface utilizes fare calculation software 826 to calculate an ongoing fare as well as a final fare for display on display/keyboard 816, touchscreen 830 and/or mobile phone 880. Fare calculation software 826 may utilize data 822 for information such as cost per distance driven, cost per time traveled, etc. Fare calculation software 826 may utilize GPS unit 819 for distance traveled or communicate with the taxi odometer through near field communication unit 817. Final payment by the passenger may be made through a credit card reader or other electronic means also in communication with the driver system through near field communication unit 817. Approval for the credit card or other electronic payment may be obtained through radio/cellular communications 818 to server 850 to a third party approver such as a credit card company.

Driver system 800 can also provide taxi location information to server 850 by obtaining that information from GPS unit 819 and relaying that information to server 850 through radio/cellular communications 818. This information may be useful for the central facility to dispatch the taxi to a prospective passenger, and for the central facility to determine road conditions based on the travel history of the taxi.

Driver system 800 may perform other functions not described herein such as maintaining financial data for reporting and/or tax collection purposes, maintenance information regarding the taxi including scheduling upcoming maintenance, etc. Other types of hardware and software may communicate with driver system 800 such as driver systems from other taxis

In FIG. 8B touchscreen 830 is shown with a processing unit 840 and memory 841. The processing unit may communicate through an I/O (input/output) device 843 to a display output 845, a display input 847 and a communications unit 849. Since the touchscreen is utilized for both input and output, separate communication units are shown, although alternative embodiments may utilize other configurations. Communications 849 may be a near field communications unit for communicating with driver system 800 or other systems as desired by the driver. Touchscreen 830 is configured as a relatively dumb terminal to driver system 800 in this embodiment, although other configurations may be utilized. Alternative embodiments may utilize other types of devices for communication with the passenger such as a terminal with a display and mouse.

In FIG. 8C server 850 is shown with a processing unit(s) 855 and memory 860. Processing unit(s) 855 may be a single processor, multi-processor, or even a cloud configuration across the internet. Memory 860 may include dispatcher database 861, map database 862, current road condition database 863, real-time taxi tracking data 864, fare estimation software 865, taxi tracking software 866 and user interface 867. The processing unit may communicate through an I/O (input/output) device 870 to a radio communications unit 872, cellular communications unit 874 and a local interface 876. Radio communications unit 872 and cellular communications unit 874 may be utilized to communicate with a taxi driver system. Cellular communications unit 874 may be utilized to communication with a prospective passenger mobile phone 880. Local interface 876 may be utilized by a person conducting maintenance on the server, or for lining with third party providers to obtain real-time road condition information. Other types of software and hardware may be utilized in alternative embodiments.

Dispatcher database 861 includes information useful for dispatching taxis to prospective passengers include records of each taxi including the type of taxi (e.g. car or van), handicap capabilities (e.g. can handle wheelchair bound passengers, driver name and contact information, general area of coverage, and real-time information such as current location and whether the taxi is currently available or not.

Map database 862 includes mapping information of the area of prospective passengers, typically a city and surrounding areas. This includes information needed to generate possible routes such as street location and length, which streets intersect and which locations, whether a given street is one-way, etc. In this embodiment, a map is composed of a set of road segments and intersections, each segment representing a portion of a road, such as between intersections with other roads. Information about each segment can include distance, number of lanes, direction, speed limit, etc. Information about each intersection may include whether there is a stop sign or traffic light, which road has priority, etc.

Current road condition database 863 includes real-time information about current traveling conditions and pricing of road segments and intersections as well as static conditions and pricing. Current traveling information maintained real-time includes location events (e.g. sports events, parades), weather conditions, speed limits, road projects, road conditions, traffic patterns, traffic congestions, traffic light information, etc. In addition, pricing information, which may be dynamic, includes taxi rates and tolls. Much of this information may be real-time such as current actual speeds of vehicles at various locations within the coverage area or identification of areas where lanes may be closed or potholes may exist, etc. Some of this real-time information may be provided by third party vendors or information from the real-time taxi tracking data.

Real-time taxi tracking data 864 includes information about the taxis being tracked throughout the coverage area. This may be used to modify or supplement the road condition database. This information is obtained from the GPS units of each taxi that transmits this information to the server real-time. This information may be segregated by taxis that are currently transporting passengers and those that are not currently transporting passengers. If a taxi is not transporting a passenger, that taxi may drive more slowly by locations such as hotels and other business looking for passengers, thereby providing data that is not accurate for determining road conditions. This database is managed by taxi tracking software 866.

Fare estimation software 865 utilizes the map database 862 and road condition database 863 to estimate fares for a prospective passenger given the current location (point of origin), destination and criteria of the prospective passenger. Fare estimation software may be utilized by user interface 867.

User interface 867 is utilized by processing unit(s) 855 for interfacing with a prospective passenger mobile phone application. User interface 867 can utilize the fare estimation software 865 to generate and provide information to the prospective passenger based on input from that passenger. Fare estimation software 865 can be utilized by the user interface to provide an estimate of a fare based on a current location and destination of the prospective passenger and any criteria the prospective passenger may provide such as a request to minimize cost, to minimize time traveled, or some combination such as to get to the destination within 20 minutes with the cheapest fare possible within that timeframe. The current location can be determined by a mobile phone GPS unit or by a description by the prospective passenger such as through voice recognition. The destination and criteria can be provided by the prospective passenger and may be entered by the prospective passenger through though mobile phone 880, or by other types of communication such as voice recognition. Fare estimation software can then determine various routes including respective fare costs and travel time estimations for display to the driver and prospective passenger by the user interface through mobile phone 880. The server fare estimation software 867 can utilize the databases and software in memory 860 to provide the estimates based on a variety of factors including current road conditions. The prospective passenger can then either approve or reject the estimates or provide alternative routes for further estimation to the user interface utilizing mobile phone 880.

Once the prospective passenger has accepted the ride, has been picked up by the taxi and the trip has started, the user interface may invoke the driver system user interface to continue the interaction with the passenger including showing actual fare cost, comparing the actual with the estimate, and for handling final payment. More details of this software will be described below with reference to FIG. 9.

In FIG. 8D mobile phone 880 is shown with a processing unit 882 and memory 884. Memory 884 may include application 886 and data 888. The processing unit may communicate through an I/O (input/output) device 890 to a display output 892, a display input 894, a GPS unit 896, and a communications unit 898.

Application 886 may be used by a prospective passenger to interact with the server user interface through cellular communications unit 898. Through this interaction, the prospective passenger can obtain an estimated time of arrival of the taxi and an estimated fare cost and time of travel.

FIG. 9 is a flow diagram of a user interface for estimating a taxi fare in accordance with a second embodiment. The user interface can utilize fare estimation software 865 to generate and provide an estimated fare for a prospective passenger.

In a first step 900, the server user interface determines whether it has been queried for estimation of a fare. This may be from a prospective customer mobile phone application. If not then processing returns to step 900. This step is then performed repeatedly until a query is received or until the user interface is turned off by an operating system, typically at the request of the driver. If a query is received in step 900, then processing continues to step 905 where a point of origin (typically the location of the mobile phone), destination, and criteria of a prospective passenger is received, determined or otherwise obtained. In this embodiment, the current location of the prospective passenger is the location of the mobile phone which may be provided by the GPS unit of the mobile phone. The destination is provided by the passenger and may be entered by the drive on the driver system or by the passenger on the touchscreen. The criteria may include a request to minimize cost, to minimize time traveled, or some combination such as a request to get to the destination at a certain time such as for an appointment with the cheapest fare possible while meeting the destination time requested. If the prospective passenger does not provide criteria, default criteria may be utilized.

Subsequently in step 910, an estimated time to reach the prospective passenger is determined. This can include identifying which taxis meeting the criteria of the prospective passenger are available and near the point of origin and an estimated time for a taxi to reach the passenger. This estimated time may utilize the same process described below with reference to FIG. 9.

Subsequently in step 915, one or more routes from the passenger point of origin to the passenger destination are identified by the server fare estimation software using the map database at the request of the user interface and/or server fare estimation software. Then in step 920, the speed and distance of each route is determined by the server fare estimation software using the current road condition database. In step 925, the fare estimation software can then determine the cost of each route and apply the earlier specified criteria. As a result, some routes may then be discarded based on their cost, time of travel or other criteria. Alternative embodiments may repeat steps 915 through 925 seeking additional alternative routes which may better meet the criteria.

Subsequently in step 930, this information (e.g. time for taxi to arrive, routes, cost, distance, travel time to destination, etc.) is displayed to the prospective passenger on the mobile phone display. An example of such a display of information is shown and described below with reference to FIG. 6. The prospective passenger can then review this information and either accept or reject the estimated fares for the given routes in step 940. If the prospective passenger rejects the proposed routes and estimated fares, then the passenger can provide possible alternate routes in step 945. If such an alternate is provided in step 945, then processing returns to step 920 for processing. If no such alternate is provided, the processing continues to step 948. In step 948, the user may provide alternative criteria than set forth previously. If alternate criteria are provided, the processing returns to step 910, otherwise processing returns to step 900.

If the prospective passenger accepts a proposed route and estimated fare in step 940, then in step 950 a taxi is dispatched to pick up the passenger and the server user interface passes the relevant information to the driver system user interface such as the route, estimated fare, etc. Once the passenger is picked up, the taxi meter is started in step 955, thereby initiating the driver system fare calculation software for calculating and displaying the actual ongoing fare to the passenger during the trip to the passenger destination along the route selected by the passenger. The actual ongoing fare may be constantly compared to an estimated time throughout the trip so the passenger can see whether the actual travel is ahead of or behind the estimated time. As the trip progresses, an internal query determines whether the taxi has reached the destination in step 960. This can be performed by comparing the current location of the taxi with the passenger destination or by the taxi driver indicating the destination has been reached through the driver system keyboard. If not, then the GPS data for the taxi is sent to the server in step 965 and processing returns to step 960. This information is utilized by the system server taxi tracking software to update the real-time taxi tracking data which is further used to update the road condition database.

If the destination has been reached in step 960, then in step 970 the final actual fare is calculated and compared to the estimated fare. This is displayed to the driver and user on the driver system display and the touchscreen display. In this embodiment, processing then continues to step 975 for collecting payment. In alternative embodiments, if the difference is significantly different to the passenger's detriment, then a discount may be provided to the passenger. In step 975, payment is received from the passenger and processing returns to step 900 above until another query is received.

As will be appreciated by one skilled in the art, the above embodiments may be easily extended to multiple passengers sharing a ride including having multiple destinations in sequence. For example, if two riders are sharing a ride where there is one point of origin for both riders, but different destinations, the user interface may simply utilize the fare estimation software to provide estimated routes and fares from the point of origin to the first destination and then from the first destination to the second destination, and from the point of origin to the second destination and from the second destination to the first destination, and then compare the results. The passengers may also specify in the criteria the order of destinations reached and any time constraints for each destination.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for estimating a taxi fare. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing an estimated taxi fare to a passenger comprising:
providing a user interface (UI) for identifying a route and the estimated taxi fare for travelling the route in a taxi from a point of origin to a destination meeting a set of criteria; and
responsive to the passenger utilizing the UI with the point of origin and identifying the destination:
accessing a set of databases with a set of real-time information including traveling related information and pricing information,
identifying the route and the estimated taxi fare for the route based upon the point of origin, the destination, the set of criteria, and the set of real-time information, and
presenting the estimated taxi fare to the passenger.

2. The method of claim 1 wherein the set of real-time information includes one or more items selected from the group of location events, weather conditions, speed limits, road projects, road conditions, traffic patterns, traffic congestions, traffic light information, taxi rates, and tolls.

3. The method of claim 1 wherein the passenger utilizes the UI to provide the set of criteria.

4. The method of claim 3 wherein the set of criteria includes one or more from the set of minimum cost, minimum travel time, and minimum cost within a given travel time.

5. The method of claim 3 wherein the UI supports the passenger providing a new set of criteria and in response dynamically identifying a new route and a new estimated taxi fare for the new route based upon the point of origin, the destination, the new set of criteria, and the set of real-time information

6. The method of claim 1 wherein the route is presented to the passenger.

7. The method of claim 6 wherein the UI supports the passenger selecting an alternative route and in response dynamically identifying a new estimated taxi fare for the alternative route based upon the point of origin, the destination, and the set of real-time information.

8. The method of claim 1 wherein the UI supports tracking a location of the taxi from the point of origin to the destination, determining an actual fare, and presenting the actual fare to the passenger.

9. The method of claim 8 wherein the actual fare is compared to the estimated fare.

10. The method of claim 8 wherein the tracked location of the taxi is used to adjust the real-time information.

11. A computer usable program product comprising a computer usable storage medium including computer usable code for use in providing an estimated taxi fare to a passenger, the computer usable program product comprising code for performing the steps of:
providing a user interface (UI) for identifying a route and the estimated taxi fare for travelling the route in a taxi from a point of origin to a destination meeting a set of criteria; and
responsive to the passenger utilizing the UI with the point of origin and identifying the destination:
accessing a set of databases with a set of real-time information including traveling related information and pricing information,
identifying the route and the estimated taxi fare for the route based upon the point of origin, the destination, the set of criteria, and the set of real-time information, and
presenting the estimated taxi fare to the passenger.

12. The computer usable program product of claim 11 wherein the passenger utilizes the UI to provide the set of criteria.

13. The computer usable program product of claim 12 wherein the UI supports the passenger providing a new set of criteria and in response dynamically identifying a new route and a new estimated taxi fare for the new route based upon the point of origin, the destination, the new set of criteria, and the set of real-time information

14. The computer usable program product of claim 11 wherein the route is presented to the passenger and wherein the UI supports the passenger selecting an alternative route and in response dynamically identifying a new estimated taxi fare for the alternative route based upon the point of origin, the destination, and the set of real-time information.

15. The computer usable program product of claim 11 wherein the UI supports tracking a location of the taxi from the point of origin to the destination, determining an actual fare, comparing the actual fare to the estimated fare, and presenting the actual fare and estimated fare to the passenger.

16. A data processing system for providing an estimated taxi fare to a passenger, the data processing system comprising:
a processor; and
a memory storing program instructions which when executed by the processor execute the steps of:
providing a user interface (UI) for identifying a route and the estimated taxi fare for travelling the route in a taxi from a point of origin to a destination meeting a set of criteria; and
responsive to the passenger utilizing the UI with the point of origin and identifying the destination:
accessing a set of databases with a set of real-time information including traveling related information and pricing information,
identifying the route and the estimated taxi fare for the route based upon the point of origin, the destination, the set of criteria, and the set of real-time information, and
presenting the estimated taxi fare to the passenger.

17. The data processing system of claim 16 wherein the passenger utilizes the UI to provide the set of criteria.

18. The data processing system of claim 17 wherein the UI supports the passenger providing a new set of criteria and in response dynamically identifying a new route and a new estimated taxi fare for the new route based upon the point of origin, the destination, the new set of criteria, and the set of real-time information

19. The data processing system of claim 16 wherein the route is presented to the passenger and wherein the UI supports the passenger selecting an alternative route and in response dynamically identifying a new estimated taxi fare for the alternative route based upon the point of origin, the destination, and the set of real-time information.

20. The data processing system of claim 16 wherein the UI supports tracking a location of the taxi from the point of origin to the destination, determining an actual fare, comparing the actual fare to the estimated fare, and presenting the actual fare and estimated fare to the passenger.
